(19) United States
(12) Patent Application Publication
(10) Pub. No.: US 2016/0165108 A1
(43) Pub. Date: Jun. 9, 2016

(54) CAMERA MODULE

(71) Applicant: Samsung Electro-Mechanics Co., Ltd., Suwon-si (KR)

(72) Inventors: Jin Bok JANG, Suwon-si (KR); Kyoung Soo SON, Suwon-si (KR)

(73) Assignee: Samsung Electro-Mechanics Co., Ltd., Suwon-si (KR)

(21) Appl. No.: 14/954,478

(22) Filed: Nov. 30, 2015

(30) Foreign Application Priority Data
Dec. 9, 2014 (KR) 10-2014-0175646

(51) Int. Cl. H04N 5/225; G02B 1/11; G02B 7/02; G02B 5/20; G02B 7/00

(52) U.S. Cl. CPC H04N 5/2254; G02B 5/208; G02B 7/006; G02B 7/02; G02B 1/11

(57) ABSTRACT

A camera module includes: a housing including an accommodating space configured to accommodate a lens part, the housing including an upper surface and a first opening in the upper surface configured to expose the lens part; a seating part recessed in a portion of a lower surface of the housing and including a second opening configured to allow light incident to the lens part to pass therethrough; a protrusion part protruding from the seating part in a downward direction of the housing; and an infrared cut-off filter including a through-hole in a position corresponding to a position of the protrusion part such that the protrusion part is inserted into the through-hole and the infrared cut-off filter is seated in the seating part.

### CROSS-REFERENCE TO RELATED APPLICATION(S)

This application claims the benefit of Korean Patent Application No. 10-2014-0175646 filed on Dec. 9, 2014 in the Korean Intellectual Property Office, the entire disclosure of which is incorporated herein by reference for all purposes.

### BACKGROUND

1. Field

The following description relates to a camera module.

2. Description of Related Art

Recently, portable terminals such as mobile phones, personal digital assistants (PDAs), or the like, have been used as multi-convergence devices capable of playing music, movies, television shows, video games, and the like, as well as performing a simple telephone function in accordance with the development of technology. A camera module may be the most representative device for implementing a multi-convergence function.

In addition, a camera module having an auto-focus (AF) function or a zoom function has been demanded by users. Various devices performing additional functions may be mounted in the camera module in order to give particular effects to an image photographed in the camera module.

In particular, the camera module may include an infrared cut-off filter. The infrared cut-off filter is a component that filters infrared rays from light. The infrared cut-off filter may be coupled to a housing, and the housing may be provided with a part to which the infrared cut-off filter is coupled. An example of a camera module including an infrared cut-off filter is disclosed in Korean Patent Laid-Open Publication No. 10-2014-0118627.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to one general aspect, a camera module includes: a housing including an accommodating space configured to accommodate a lens part, the housing including an upper surface and a first opening in the upper surface configured to expose the lens part; a seating part recessed in a portion of a lower surface of the housing and including a second opening configured to allow light incident to the lens part to pass therethrough; a protrusion part protruding from the seating part in a downward direction of the housing; and an infrared cut-off filter including a through-hole in a position corresponding to a position of the protrusion part such that the protrusion part is inserted into the through-hole and the infrared cut-off filter is seated in the seating part.

The camera module may further include an adhesive material disposed between the seating part and the infrared cut-off filter and bonding the infrared cut-off filter to the housing.

The seating part may include accommodating parts extended from respective corner regions of the seating part in an outward direction.

The infrared cut-off filter may include a coating material applied thereto, the coating material being configured to cover an edge portion of the second opening of the seating part and block scatter-reflected light.

The coating material may be applied in a chamfered shape in which each corner portion of the coating material is obliquely chamfered.

The protrusion part may include a plurality of protrusion parts having different diameters, and the through-hole may include a plurality of through-holes having different diameters in positions corresponding to those of the plurality of protrusion parts.

An end portion of the protrusion part may be chamfered.

The camera module may further include: an image sensor disposed below the housing, and configured to receive light passing through the lens part and convert the received light into electrical signals; and a printed circuit board coupled to a lower surface of the image sensor.

The lower surface may include protruding edge portions, and the printed circuit board may be coupled to the edge portions.

The camera module may further include a shielding member coupled to the housing and covering side surfaces of the housing, and configured to shield an external electromagnetic influence.

According to another general aspect, a camera module includes: a housing including an accommodating space configured to accommodate a lens part, the housing including an upper surface and a first opening in the upper surface configured to expose the lens part; a seating part recessed in a portion of a lower surface of the housing and including a second opening configured to allow light incident to the lens part to pass therethrough; one or more protrusion parts protruding from the housing; and an infrared cut-off filter retained in the seating part by the one or more protrusion parts.

The one or more protrusion parts may include a plurality of protrusion parts disposed at corner regions of the seating part.

The infrared cut-off filter may include one or more through-holes, and the one or more protrusion parts may be inserted in the one or more through-holes.

The seating part may include a recessed surface disposed in a plane intersecting an optical axis direction of the camera module, and a step surface extending parallel to the optical axis direction. The infrared cut-off filter may be disposed on the recessed surface. The one or more protrusion parts may be configured to prevent the infrared cut-off filter from contacting the step surface.

Other features and aspects will be apparent from the following detailed description, the drawings, and the claims.

### BRIEF DESCRIPTION OF THE DRAWINGS

FIG. 1 is an exploded perspective view illustrating a camera module according to an example.

FIG. 2 is a bottom perspective view of the camera module according to an example.

FIG. 3 is a view illustrating a protrusion part illustrated in FIG. 2.

FIG. 4 is a cross-sectional view of the camera module taken along line I-I of FIG. 2; and

FIGS. 5 and 6 are enlarged views of region A of FIG. 4.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

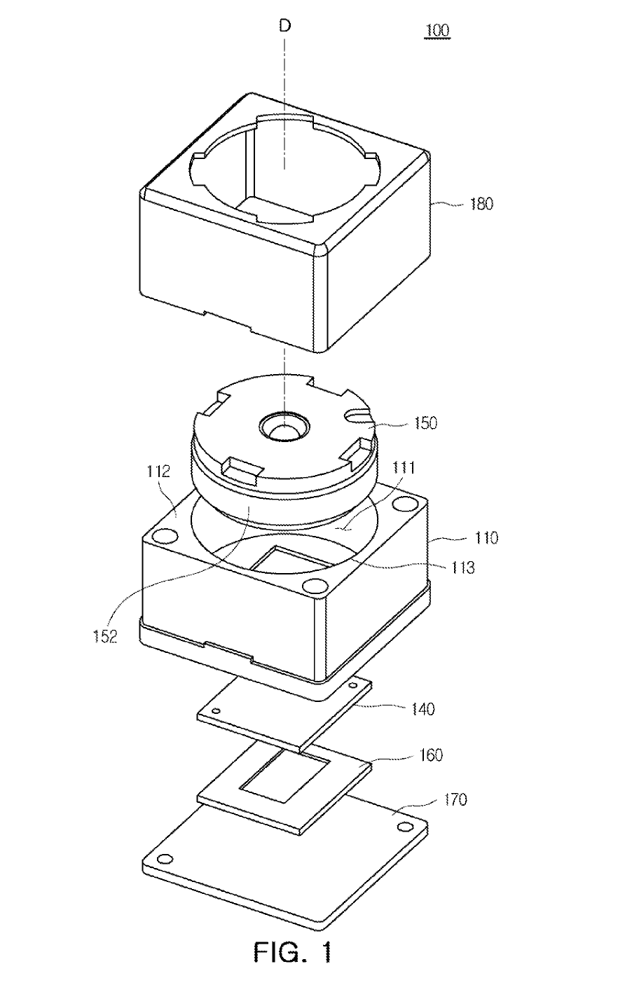

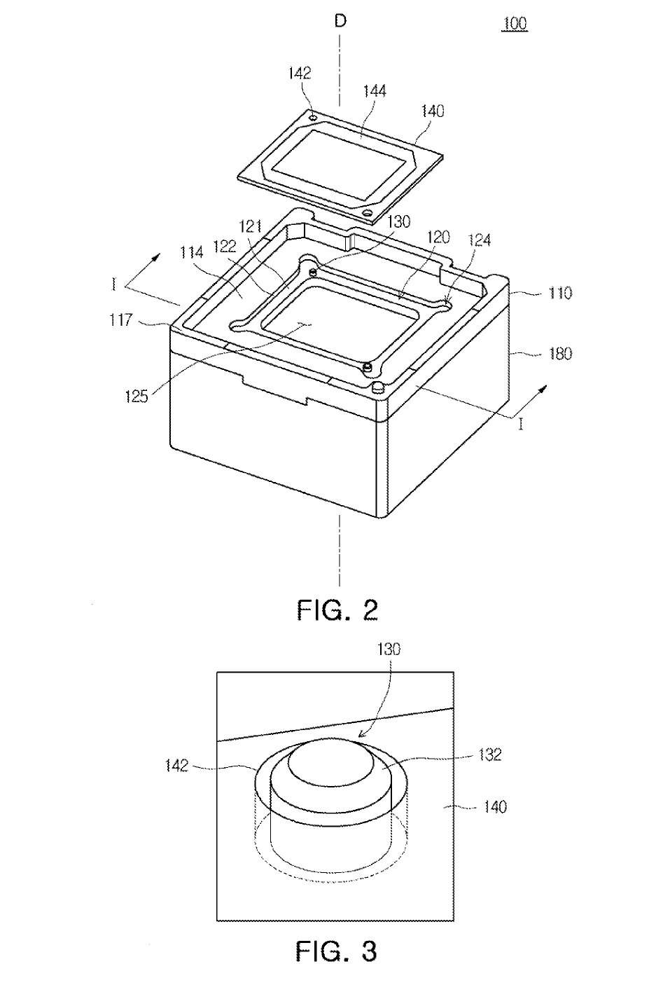

FIG. 1 is an exploded perspective view illustrating a camera module 100 according to an example, and FIG. 2 is a bottom perspective view of the camera module 100.

Referring to FIGS. 1 and 2, the camera module includes a housing 110, a seating part 120, protrusion parts 130, and an infrared cut-off filter 140.

As shown in FIG. 1, the housing 110 includes an accommodating space 111 configured to accommodate a lens part 150 therein, and includes a first opening 113 in an upper surface 112 thereof to expose the lens part 150. The accommodating space 111 may have a shape corresponding to that of the lens part 150. In addition, the housing 110 includes an internal space configured to accommodate components other than the lens part 150. That is, the internal space of the housing 110 may accommodate components required for driving the lens part 150, and the like, wherein the internal space corresponds to a position at which respective components are coupled to each other.

In addition, the first opening 113 is disposed in the upper surface 112 of the housing 110 so that light may be incident to the lens part 150. The first opening 113 may expose the entirety of the upper surface 112 of the lens part 150, or may expose only a portion of the upper surface 112 of the lens part 150.

The lens part 150 includes one or more lenses (not shown) and a lens barrel 152. The lens part 150 is configured to transmit light therethrough. As illustrated in FIG. 1, the lens barrel 152 may have a cylindrical shape. However, the lens barrel 152 is not limited to having the cylindrical shape, and may have various shapes such as a polygonal shape.

Referring to FIGS. 1 and 2, the upper surface 112 and a lower surface 114 (FIG. 2) of the housing 110 intersect with (i.e., extend in a direction transverse to) an optical axis direction D of the lens part 150, the first opening 113 is disposed in the upper surface 112 of the housing 110, and the seating part 120 (FIG. 2) is disposed in the lower surface 114 of the housing 110.

As shown in FIG. 2, the seating part 120 is formed by a recessed portion of the housing 110 that is recessed from the lower surface 114, and includes a second opening 125 configured to allow light incident to the lens part 150 to pass therethrough. The recessed portion of the housing 110 at which the seating part 120 is disposed corresponds to a position of the lens part 150 when the lens part 150 is accommodated in the housing 110.

As illustrated in FIG. 2, the seating part 120 is recessed from the lower surface 114 of the housing 110 and is stepped with respect to the lower surface 114 of the housing 110. The seating part 120 includes recessed surfaces 121 intersecting with the optical axis direction D of the lens part 150 and step surfaces 122 disposed in parallel with the optical axis direction D. That is, the recessed surfaces 121 of the seating part 120 may be disposed in parallel with the lower surface 114 of the housing 110, and the step surfaces 122 of the seating part 120 may connect the lower surface 114 of the housing 110 and the recessed surfaces 121 of the seating part 120 to each other.

The seating part 120 is recessed from the lower surface 114 of the housing 110 by a height of the step surface 122. Therefore, a distance from the recessed surfaces 121 of the seating part 121 to the lens part 150 may be shorter than a distance from the lower surface 114 of the housing 110 to the lens part 150. The seating part 120 may have a quadrangular shape, as illustrated in FIG. 2. However, the seating part 120 is not limited to having the quadrangular shape, and may have a shape other than the quadrangular shape, depending on a shape of the infrared cut-off filter 140 described below.

The seating part 120 may have an area larger than an area of the infrared cut-off filter 140 in order to secure an assembling tolerance between the seating part 120 and the infrared cut-off filter 140 when the infrared cut-off filter 140 is coupled to the housing 110. Therefore, a size and a shape of the seating part 120 may correspond to a size and shape of the infrared cut-off filter 140.

Referring to FIG. 1, the second opening 125 is formed of the seating part 120, and light incident to the lens part 150 may pass through the second opening 125 and then arrive at an image sensor 160, which is described below. That is, the light may be incident to the lens part 150 through the first opening 113 in the upper surface 112, and the light incident to the lens part 150 may arrive at the image sensor 160 through the second opening 125 of the seating part 120.

As illustrated in FIG. 2, the protrusion parts 130 protrude from the seating part 120 in a downward direction of the housing 110. In detail, the protrusion parts 130 protrude from the recessed surface 121 of the seating part 120 in the downward direction of the housing 110. The downward direction of the housing 110 refers to a direction from the upper surface 112 toward the lower surface 114. Thus, the protrusion parts 130 protrude from the seating part 120 in a direction away from the upper surface 112.

The protrusion parts 130 may have a cylindrical shape and a circular cross section. However, the protrusion parts 130 are not limited to having the cylindrical shape, and may have a polygonal pillar shape and a polygonal cross section. In addition, although two protrusion parts 130 are shown, one or more protrusion parts 130 may be provided, and the positions of the protrusion parts 130 are not limited to those illustrated in FIG. 2.

The infrared cut-off filter 140 includes through-holes 142 formed in positions corresponding to the positions of the protrusion parts 130 so that the protrusion parts 130 are inserted into the through-holes 142, and is seated in the seating part 120 to thereby be coupled to the housing 110. The infrared cut-off filter 140 is disposed at a lower portion of the housing 110 and is configured to block light in an infrared band in light passing through the lens part 150.

The infrared cut-off filter 140 may be a glass-type filter or a film-type filter, and may have a quadrangular shape. However, the infrared cut-off filter 140 is not limited to having the quadrangular shape, and may have various shapes, and the seating part 120 may be recessed from the lower surface 114 of the housing 110 to have a shape corresponding to that of the infrared cut-off filter 140, as described above.

The infrared cut-off filter 140 is seated in the seating part 120 to thereby be coupled to the housing 110. That is, the infrared cut-off filter 140 is disposed in the seating part 120 so that one surface of the infrared cut-off filter 140 contacts the recessed surface 121 of the seating part 120 to thereby be coupled to the housing 110. Since the infrared cut-off filter 140 is coupled to the housing 110 without being separated from the seating part 120 by the step surfaces 122, the infrared cut-off filter 140 is stably coupled to the housing 110.

In a case in which the infrared cut-off filter 140 is seated in the seating part 120, the side surfaces of the infrared cut-off filter 140 face the step surfaces 122 of the seating part 120. Each step surface 122 covers at least a portion of the corresponding side surface of the infrared cut-off filter 140, and a height of the step surfaces 122 may be substantially the same as or larger than a thickness of the infrared cut-off filter 140.

In addition, since the infrared cut-off filter 140 is seated in the seating part 120 by inserting the protrusion parts 130 into the through-holes 142, the infrared cut-off filter 140 is coupled to the housing 110 while maintaining a precise position.

In detail, as described above, the seating part 120 may have an area larger than that of the infrared cut-off filter 140 in order to secure assembling tolerance. Therefore, in this case, the infrared cut-off filter 140 may move in one direction by a maximum assembling tolerance in the seating part 120.

In a case in which the infrared cut-off filter 140 is coupled to the housing 110 without the protrusion parts 130 on the seating part 120, the infrared cut-off filter 140 may move in the seating part 120, and thus a position of the infrared cut-off filter 140 may not be precisely controlled. Even though the infrared cut-off filter 140 may be coupled to the housing 110 without being separated from the seating part 120, the infrared cut-off filter 140 may be coupled to the housing 110 to be biased toward one side of the seating part 120. In this case, a position of the infrared cut-off filter 140 may not be uniform in every camera module.

Conversely, in the case described herein, in which the infrared cut-off filter 140 is coupled to the housing 110 by inserting the protrusion parts 130 on the seating part 120 into the through-holes 142 of the infrared cut-off filter 140, movement of the infrared cut-off filter 140 in the seating part 120 is limited by the protrusion parts 130. As a result, in the camera module 100, positions of the protrusion parts 130 and positions of the through-holes 142 formed in the infrared cut-off filter 140 may be adjusted to control a final assembled position of the infrared cut-off filter 140.

The camera module 100, may further include an adhesive material interposed between the seating part 120 and the infrared cut-off filter 140 to thereby bond the infrared cut-off filter 140 to the housing 110. Thus, the seating part 120 and the protrusion parts 130 control a position of the infrared cut-off filter 140 in the housing 110, and the adhesive material applied to the seating part 120 may provide coupling force fixing the infrared cut-off filter 140 to the housing 110.

The adhesive material may be applied onto the recessed surface 121 of the seating part 120, and may be an ultraviolet (UV) curable adhesive, for example. The adhesive material may be interposed between the seating part 120 and the infrared cut-off filter 140 to thereby firmly fix and couple the infrared cut-off filter 140 to the housing 110.

Still referring to FIG. 2, the seating part 120 further includes accommodating parts 124 extended from respective corner regions of the seating part 120 in an outward direction. The accommodating parts 124 are configured to accommodate an adhesive material pushed out by compression of the infrared cut-off filter 140 at the time of seating the infrared cut-off filter 140 in the seating part 120 therein. That is, the adhesive material may have fluidity, and when the infrared cut-off filter 140 is applied on the adhesive material after the adhesive material is applied to the seating part 120, the adhesive material may be pushed out by a load of the infrared cut-off filter 140. Thus, the accommodating parts 124 are provided in the seating part 120 to accommodate the adhesive material therein and thereby prevent the adhesive material from flowing to other components.

Some of the light passing through the lens part 150 may be scatter-reflected on an inner wall surface of the housing 110, and may pass through the infrared cut-off filter 140, and may then be introduced into the image sensor 160. In this case, a flare phenomenon that an image becomes unclear or a round spot appears may occur. In order to prevent the flare phenomenon, the infrared cut-off filter 140 further includes a coating material 144 applied thereto in order to cover an edge portion of the second opening 125 of the seating part 120 and thereby block scatter-reflected light.

The coating material 144 may be applied to regions adjacent to outer edges of the infrared cut-off filter 140 except for a central region of the infrared cut-off filter 140. Accordingly, the infrared cut-off filter 140 may pass normally refracted light in light passing through the infrared cut-off filter 140 and block the scatter-reflected light in the light passing through the infrared cut-off filter 140. When the infrared cut-off filter 140 is seated in the seating part 120 to thereby be coupled to the housing 110, the coating material 144 applied to the infrared cut-off filter 140 may be disposed to cover the edge portions of the second opening 125.

The coating material 144 is applied onto at least one surface of the infrared cut-off filter 140. That is, the coating material 144 may be applied onto a surface of the infrared cut-off filter 140 contacting the recessed surface 121 of the seating part 120, onto an opposite surface to the surface of the infrared cut-off filter 140 contacting the recessed surface 121 of the seating part 120, or onto both of these surfaces of the infrared cut-off filter 140. The coating material 144 may be a material that reflects light.

In addition, the coating material 144 may be applied in a chamfered shape in which each corner portion thereof is obliquely chamfered. In a case in which the coating material 144 is applied in a chamfered shape, a wider area of the infrared cut-off filter 140 may be firmly coupled to the housing 110. That is, in a case in which the adhesive material interposed between the infrared cut-off filter 140 and the seating part 120 is a UV curable adhesive, UV light needs to arrive at the adhesive material in order to cure the adhesive, and since the coating material 144 applied to the infrared cut-off filter 140 may block the UV light, the adhesive material may be applied to portions of the infrared cut-off filter 140 that are on the recessed surface 121 of the seating part 120 and are not covered by the coating material 144.

When the coating material 144 is applied to the infrared cut-off filter 140 in the chamfered shape, the coating material 144 is not applied to respective corner regions of the infrared cut-off filter 140 by chamfered portions. Therefore, regions that are not covered by the coating material 144 of the infrared cut-off filter 140 on the recessed surface 121 of the seating part 120 may be increased, and an amount of the applied adhesive material may be increased. As a result, the infrared cut-off filter 140 may be more firmly coupled to the housing 110.

As illustrated in FIG. 2, two protrusion parts 130 may be disposed in corner regions of the seating part 120 positioned along a diagonal line of the seating part 120, respectively, or may be disposed at both corners of any one edge of the seating part 120, respectively. The protrusion parts 130 may have different diameters, respectively. Correspondingly, the through-holes 142 of the infrared cut-off filter 140 may have different diameters, respectively, to correspond to the respective protrusion parts 130 inserted therein. In a case in which the protrusion parts 130 and the through-holes 142 are provided as described above, a protrusion part 130 may only be inserted into a through-hole 142 having a corresponding diameter.

Only one of the surfaces of the infrared cut-off filter 140 intersecting with the optical axis direction D of the lens part 150 may be a contact surface. That is, in a case in which one surface of the infrared cut-off filter 140 contacting the seating part 120 is determined, if the other surface of the infrared cut-off filter 140 is coupled to the housing 110 to contact the seating part 120, a product defect may be caused. Therefore, in a case in which the protrusion parts 130 have different diameters, when the other surface of the infrared cut-off filter 140 is coupled to the housing 110 to contact the seating part 120, diameters of the through-holes 142 formed in the infrared cut-off filter 140 and the protrusion parts 130 may be different from each other, and thus the infrared cut-off filter 140 and the housing 110 cannot be coupled to each other. Therefore, product defects may be prevented.

For example, in a case in which the protrusion parts 130 have diameters of D1 and D2, respectively, a diameter of the through-hole 142 corresponding to the protrusion part 130 having the diameter of D1 is D3, a diameter of the through-hole 142 corresponding to the protrusion part 130 having the diameter of D2 is D4, and the diameters have a relationship of D3>D1>D4>D2. Therefore, the protrusion part 130 having the diameter of D1 cannot be inserted into the through-hole 142 having the diameter of D4, and thus a single contact surface of the infrared cut-off filter 140 may be determined.

FIG. 3 is a view illustrating the protrusion part 130.

Referring to FIG. 3, an end portion of the protrusion part 130 includes a chamfer 132. The protrusion part 130 may therefore be more easily inserted into the infrared cut-off filter 140. That is, even if a surrounding region of the through-hole 142 is placed on the end portion of the protrusion part 130 without completely inserting the protrusion part 130 into the through-hole 142 at the time of assembling the infrared cut-off filter 140, since the end portion of the protrusion part 130 is inclined, the infrared cut-off filter 140 may slide down due to the weight of the infrared cut-off filter 140 to thereby be seated in the seating part 120.

As illustrated in FIG. 3, the size (e.g., diameter) of the through-hole 142 may be larger than that of the protrusion part 130 in order to secure an assembling tolerance between the through-hole 142 and the protrusion part 130. In addition, a protrusion length of the protrusion part 130 may be substantially the same as or longer than the thickness of the infrared cut-off filter 140.

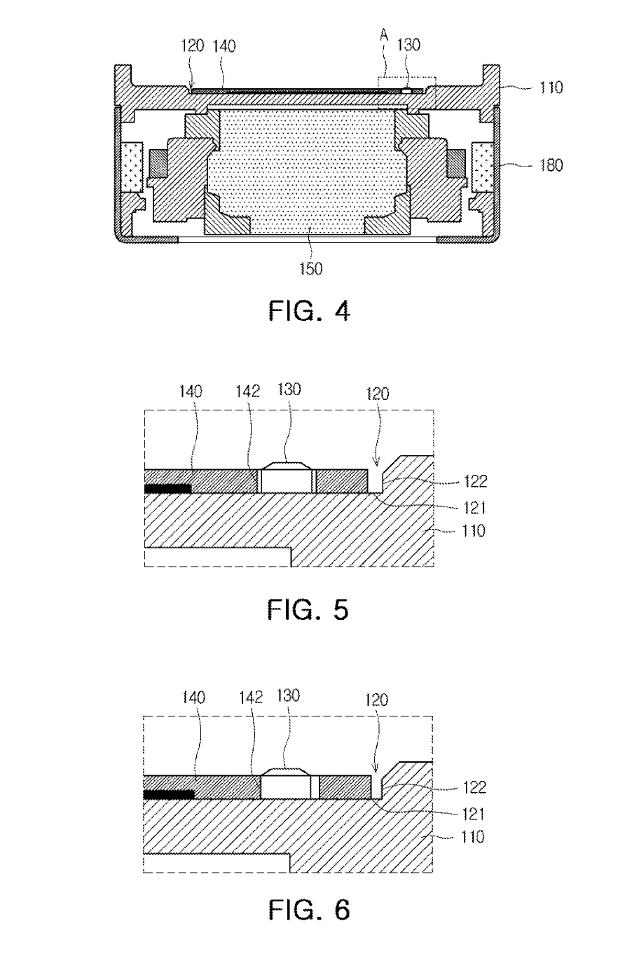

FIG. 4 is a cross-sectional view of the camera module 100 taken along line I-I of FIG. 2, and FIGS. 5 and 6 are enlarged views of region A of FIG. 4.

FIG. 4 illustrates a form in which the infrared cut-off filter 140 is seated in the seating part 120, and is thereby coupled to the housing 110. Here, the protrusion part 130 is inserted into the through-hole 142 formed in the infrared cut-off filter 140, and thus a position of the infrared cut-off filter 140 is controlled by the protrusion part 130 and the seating part 120. Next, a method of controlling the position of the infrared cut-off filter 140 by the protrusion part 130 will be described with reference to FIGS. 5 and 6.

The infrared cut-off filter 140 is coupled to the housing 110 by the adhesive material applied to the seating part 120. Here, as described above, the seating part 120 has an area wider than that of the infrared cut-off filter 140 in order to secure assembling tolerance. Therefore, since the infrared cut-off filter 140 may move during a period in which the adhesive material is cured, a position of the infrared cut-off filter 140 may not be accurately secured.

Since the seating part 120 is recessed from the lower surface of the housing 110, the infrared cut-off filter 140 may be coupled to the housing 110 without being separated from the seating part 120. However, in a case in which the side surfaces of the infrared cut-off filter 140 contact the step surfaces 122 of the seating part 120 due to assembling tolerance, external force may be applied from contact surfaces to the infrared cut-off filter 140.

In particular, in a case in which the infrared cut-off filter 140 is provided as a film type filter, the infrared cut-off filter 140 may be easily bent, even due to small external force. In addition, in a case in which the infrared cut-off filter 140 is coupled to the housing 110 in a state in which it is excessively biased toward one side of the seating part 120, light passing through the infrared cut-off filter 140 may be distorted and then collected in the image sensor.

In addition, in a case in which the coating material 144 is applied to the infrared cut-off filter 140 in order to block the scatter-reflected light, it is important to control a coupled position of the infrared cut-off filter 140. In the case in which the infrared cut-off filter 140 is coupled to the housing 110 in the state in which the infrared cut-off filter is excessively biased toward one side of the seating part 120, the coating material 144 may block the normally refracted light as well as the scatter-reflected light, and thus a defect such as a screen being covered with the coating material 144, or the like, may occur.

In detail, when one side surface of the infrared cut-off filter 140 contacts the step surface 122 of the seating part 120, such that the infrared cut-off filter 140 is coupled to the housing 110, a distance between the other side surface of the infrared cut-off filter 140 and the step surface 122 of the seating part 120 may be greater than a value of an assembling tolerance, and the coating material 144 applied to a region of the infrared cut-off filter 140 adjacent to the other side surface of the infrared cut-off filter 140 may cover the second opening 125 of the seating part 120. Therefore, the screen may be covered with the coating material 144.

The protrusion part 130 prevents the infrared cut-off filter 140 from being coupled to the housing 110 in the state in which the infrared cut-off filter 140 is excessively biased toward one side of the seating part 120, as described above. That is, in a case in which the infrared cut-off filter 140 is coupled to the housing 110 by inserting the protrusion part 130 into the infrared cut-off filter 140, a displacement amount of the infrared cut-off filter 140 is limited by the protrusion part 130, thereby preventing any one side surface of the infrared cut-off filter 140 from contacting the step surface 122 of the seating part 120.

FIG. 5 illustrates a form in which the protrusion part 130 is inserted into a central portion of the through-hole 142 formed in the infrared cut-off filter 140. Here, the protrusion part 130 is inserted into the through-hole 142 and maintained in a state in which the protrusion part 130 does not contact the through-hole 142. The diameter of the through-hole 142 is larger than that of the protrusion part 130 in order to secure assembling tolerance between the protrusion part 130 and the through-hole 142.

FIG. 6 illustrates a form in which the infrared cut-off filter 140 is biased toward one side of the seating part 120 as compared with FIG. 5. In FIG. 6, the protrusion part 130 is maintained in a state in which it contacts a portion of an inner wall surface of the through-hole 142. Therefore, although one side surface of the infrared cut-off filter 140 is positioned closer to the step surface 122 of the seating part 120 as compared with FIG. 5, the one side surface of the infrared cut-off filter 140 cannot contact the step surface 122 due to the protrusion part 130. That is, in the camera module 100, the position of the protrusion part 130 can be adjusted to control displacement of the infrared cut-off filter 140 moving in the seating part 120, thereby preventing defects such as the screen being covered with the coating material 144, or the like, that may occur in a case in which the protrusion part 130 is not present.

The position of the protrusion part 130 and the position of the through-hole 142 of the infrared cut-off filter 140 can be appropriately designed and modified in consideration of assembling tolerance.

Again referring to FIGS. 1 and 2, the camera module 100 further includes the image sensor 160, a printed circuit board 170, and a shielding member 180.

The image sensor 160 is configured to receive the light passing through the lens part 150 and convert the received light into electrical signals, and is disposed below the housing 110. The image sensor 160 is mounted on the printed circuit board 170 to thereby receive a current supplied from the printed circuit board 170.

The printed circuit board 170 is configured to supply the current for driving the lens part 150, and is disposed below the housing 110 and coupled to the housing 110. Edge portions 117 of the lower surface of the housing 110 protrude from the housing 110, and the printed circuit board 170 is coupled to the edge portions 117.

Thus, a space is secured between the housing 110 and the printed circuit board 170, and the image sensor 160 is disposed in this space.

The shielding member 180 is configured to shield electromagnetic interference (EMI) and generally encloses the housing 110 and the lens part 150. That is, the shielding member 180 shields an electromagnetic influence from the outside, and is coupled to the housing 110 to cover side surfaces of the housing 110. The shielding member 180 may have a shape and a size corresponding to the shape and size of the housing 110 and the lens part 150, and may be constructed of a material advantageous in shielding the electromagnetic interference (EMI), such as iron.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a housing comprising an accommodating space configured to accommodate a lens part, the housing comprising an upper surface and a first opening in the upper surface configured to expose the lens part;
a seating part recessed in a portion of a lower surface of the housing and comprising a second opening configured to allow light incident to the lens part to pass therethrough;
a protrusion part protruding from the seating part in a downward direction of the housing; and
an infrared cut-off filter comprising a through-hole in a position corresponding to a position of the protrusion part such that the protrusion part is inserted into the through-hole and the infrared cut-off filter is seated in the seating part.

2. The camera module of claim 1, further comprising an adhesive material disposed between the seating part and the infrared cut-off filter and bonding the infrared cut-off filter to the housing.

3. The camera module of claim 2, wherein the seating part includes accommodating parts extended from respective corner regions of the seating part in an outward direction.

4. The camera module of claim 1, wherein the infrared cut-off filter comprises a coating material applied thereto, the coating material being configured to cover an edge portion of the second opening of the seating part and block scatter-reflected light.

5. The camera module of claim 4, wherein the coating material is applied in a chamfered shape in which each corner portion of the coating material is obliquely chamfered.

6. The camera module of claim 1, wherein:
the protrusion part comprises a plurality of protrusion parts having different diameters; and
the through-hole comprises a plurality of through-holes having different diameters in positions corresponding to those of the plurality of protrusion parts.

7. The camera module of claim 1, wherein an end portion of the protrusion part is chamfered.

8. The camera module of claim 1, further comprising:
an image disposed below the housing, and configured to receive light passing through the lens part and convert the received light into electrical signals; and
a printed circuit board coupled to a lower surface of the image sensor.

9. The camera module of claim 8, wherein:
the lower surface comprises protruding edge portions; and
the printed circuit board is coupled to the edge portions.

10. The camera module of claim 8, further comprising a shielding member coupled to the housing and covering side surfaces of the housing, and configured to shield an external electromagnetic influence.

11. A camera module comprising:
a housing comprising an accommodating space configured to accommodate a lens part, the housing comprising an upper surface and a first opening in the upper surface configured to expose the lens part;
a seating part recessed in a portion of a lower surface of the housing and comprising a second opening configured to allow light incident to the lens part to pass therethrough;
one or more protrusion parts protruding from the housing; and
an infrared cut-off filter retained in the seating part by the one or more protrusion parts.

12. The camera module of claim 11, wherein the one or more protrusion parts comprise a plurality of protrusion parts disposed at corner regions of the seating part.

13. The camera module of claim 11, wherein the infrared cut-off filter comprises one or more through-holes, and the one or more protrusion parts are inserted in the one or more through-holes.

14. The camera module of claim 11, wherein:
the seating part comprises
a recessed surface disposed in a plane intersecting an optical axis direction of the camera module, and
a step surface extending parallel to the optical axis direction;
the infrared cut-off filter is disposed on the recessed surface; and
the one or more protrusion parts are configured to prevent the infrared cut-off filter from contacting the step surface.
